(19) United States
(12) Patent Application Publication
(10) Pub. No.: US 2013/0061088 A1
(43) Pub. Date: Mar. 7, 2013

(54) INFORMATION STORAGE DEVICE AND INFORMATION STORAGE METHOD

(71) Applicant: Katsuyuki Nomura, Tokyo (JP)

(72) Inventor: Katsuyuki Nomura, Tokyo (JP)

(73) Assignee: KABUSHIKI KAISHA TOSHIBA, Tokyo (JP)

(21) Appl. No.: 13/600,880

(22) Filed: Aug. 31, 2012

(30) Foreign Application Priority Data
Aug. 31, 2011 (JP) 2011-190141

(51) Int. Cl. G06F 11/16

(52) U.S. Cl. 714/6.13; 714/54; 714/6.1; 714/E11.056

(57) ABSTRACT

An information storage device includes a semiconductor memory divided into storage regions and a management unit. The management unit manages the storage regions so that any storage region which caused read or write errors a predetermined threshold number of times, which may be two or more, is made unavailable for storing data.

### CROSS-REFERENCE TO RELATED APPLICATION

This application is based upon and claims the benefit of priority from Japanese Patent Application No. 2011-190141, filed Aug. 31, 2011; the entire contents of which are incorporated herein by reference.

### FIELD

Embodiments described herein relate generally to an information storage device and an information storage method for storing information.

### BACKGROUND

Recently, the use of semiconductor memory for storing information in nonvolatile form has become popular in information storage devices. For example, SSDs (solid state drives) and SD cards with NAND memory have been adopted as semiconductor memory in information storage devices. For such information storage devices, read errors and write errors may take place as a result of the information holding characteristics of the storage elements (i.e., the memory cells).

When a read error or write error is detected, the storage element or the storage region containing the storage element where an error took place is registered as an error site. The error site may be managed in block units, and such blocks are called defective blocks. As the number of defective blocks increases, the storage region available for the storage of information decreases, reducing the usefulness of the information storage device. In consideration of such problems, technologies have been proposed for avoiding the problem of semiconductor memory that is prone to experiencing such an increase in defective blocks.

In the related art, the storage region that is managed as defective memory blocks increases as described above. That is, in the information storage device, it is hard to avoid the generation of a sizeable storage region that is unavailable for the storage of information.

### DESCRIPTION OF THE DRAWINGS

FIG. 1 is a block diagram illustrating the configuration of an electronic device equipped with SSD as an information recording device according to an embodiment.

FIG. 2 is a block diagram illustrating the configuration of the software module for executing various operations executed by the CPU according to an embodiment.

FIG. 3 is a flow chart illustrating the execution of a read operation executed by SSD according to an embodiment.

FIG. 4 is a flow chart illustrating the execution of a write operation executed by SSD according to an embodiment.

FIG. 5 is a flow chart illustrating the execution of a storage-region management process executed by SSD according to an embodiment.

### DETAILED DESCRIPTION

In general, one embodiment will be explained with reference to figures.

One embodiment disclosed herein provides an information storage device and an information storage method that can suppress the generation of a storage region that is unavailable for the storage of information.

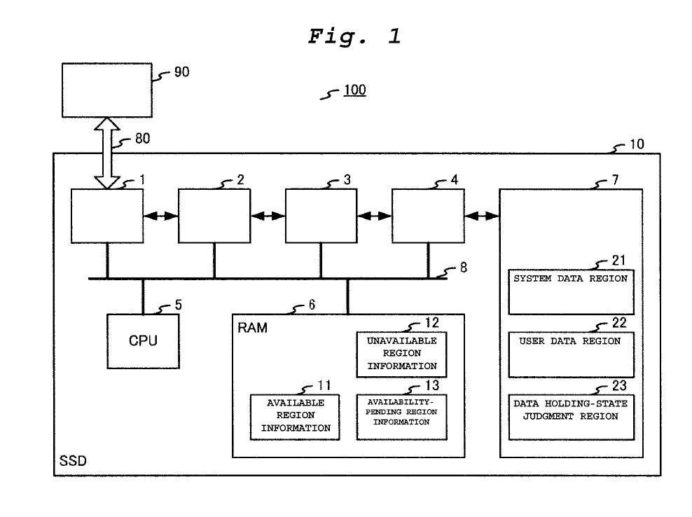

FIG. 1 is a block diagram illustrating a configuration of the electronic equipment 100 equipped with SSD (solid state drive) 10 as the information recording device according to an embodiment. Here, SSD 10 is connected to a host device 90 via the communication unit 80, and works as the storage module of the host device 90. The communication unit 80 is connected to the host device 90 and the SSD 10, and facilitates the transmission and reception of data and commands between the host device 90 and the SSD 10. For example, in one embodiment, the electronic equipment 100 is a personal computer, and host device 90 is a chip set integrated circuit (IC) in the personal computer.

The information storage device according to this embodiment has a semiconductor memory and a management unit. The semiconductor memory has a storage region for storing information. The management unit controls the functions of the SSD 10 so that among the storage regions of the semiconductor memory, a storage region is excluded from use in storing the information whenever a read error takes place in the storage region that is greater than a predetermined threshold. In some embodiments the predetermined threshold is 2 or more.

The SSD 10 of this embodiment includes a host interface (I/F) 1, a data control module 2, an error-correcting code (ECC) control module 3, a memory I/F 4, a CPU 5, a RAM 6, and a main memory 7. Some of these blocks are connected by bus 8 for the transmission/reception of information. The RAM 6 stores the available region information 11, unavailable region information 12, and availability-pending region information 13. The main memory 7 includes the storage regions including a system data region 21, a user data region 22, and data holding-state judging region 23.

In the SSD 10, write operations are executed so that the data corresponding to the data transmitted from the host device 90 are stored in the main memory 7. Also, read operations are carried out so that the data corresponding to the data requested by the host device 90 are read from the main memory 7. In this embodiment, write operations and read operations are executed in the storage regions of the main memory 7, excluding storage regions designated as unavailable for data writing or reading (hereinafter to be referred to as the defective storage region).

As to be explained later, the main memory 7 of this embodiment includes a NAND memory. A read operation for the storage medium using the NAND memory may generate the following read errors.

(1) True error caused by fatigue of the memory element due to degradation over years (i.e., defects in memory cell).

(2) Data retention error caused by storage of the data for a relatively long period of time.

(3) Read disturb errors caused by repeated read of the same memory element.

With the SSD 10 of this embodiment, generation of the defective storage region caused by read errors is suppressed.

The host I/F 1 executes communication operations for the transmission/reception of data with the host device 90. For example, the host I/F 1 executes communication operations according to the SATA (Serial Advanced Technology Attachment) standard or the SAS (Serial Attached SCSI) standard. As the host I/F 1 receives the write command for storing the data from the host device 90, the write data attached to the received write command are output to the data control module 2. Also, as the host I/F 1 receives the read command for reading data from the host device 90, the corresponding read data are input from the data control module 2.

The data control module 2 controls the caching and reordering of the data in the transmission and reception of data between host I/F 1 and ECC control module 3. Also, in the transmission/reception of data between the memory I/F 4 and the main memory 7, the data control module 2 controls the caching and reordering of the data.

In the writing and reading operations, the ECC control module 3 controls the process of correcting read and write errors. On the basis of the user data and correction code data input from the memory I/F 4, in read operations, the ECC control module 3 corrects the input user data and transmits them to the data control module 2. Also, in write operations, the ECC control module 3 generates the correction code data for the user data input from the data control module 2, and outputs the input user data and the generated correction code data to the memory I/F 4. In the process of correcting data, the ECC control module 3 executes a judgment on whether correction of the subject data can be made. In addition, when the subject data can be corrected, the ECC control module 3 executes an error-number counting process for counting the number of the error corrections that have taken place with respect to a prescribed unit (such as the recording or read unit of data with respect to the main memory 7). The ECC control module 3 transmits the result of the judgment on whether correction can be made and also transmits the result of the error-number counting process to CPU 5.

The memory I/F 4 executes transmission and reception of data with the main memory 7. The memory I/F 4 executes data transmission and reception in conjunction with a data recording unit or data read unit of the main memory 7. In addition, the memory I/F 4 deletes a portion of the data stored in the main memory 7 in the data deletion unit with respect to the main memory 7.

The CPU 5 is a processor that controls the various blocks equipped in the SSD 10 for executing programs stored in a nonvolatile storage module not shown in the figure. The CPU 5 controls write operations and read operations of data. In addition, the CPU 5 executes a storage-region management process that manages the information pertaining to storage regions of the main memory 7, including available region information 11, unavailable region information 12, and availability-pending region information 13. Also, from the ECC control module 3, the CPU 5 receives the result of the judgment on whether correction can be made and the result of the error-number counting process. On the basis of the results received from the ECC control module 3, the CPU 5 stores information in the RAM 6 about storage regions of the main memory 7 that may be utilized during write operations and/or read operations. On the basis of the result of the judgment on whether correction can be made and the result of the error-number counting process, the CPU 5 manages the information pertaining to the storage regions utilized during write operations and/or read operations, to reduce generation of the defective storage region.

The RAM 6 is a work memory for the various blocks equipped in the SSD 10. As the RAM 6, a volatile memory may be adopted, such as DRAM. In this embodiment, the RAM 6 has the following information stored in it: the available region information 11, the unavailable region information 12, and the availability-pending region information 13. These pieces of information are information related to the storage region of the main memory 7, and they are managed by the CPU 5. In some embodiments, these pieces of information are stored or read in a nonvolatile storage module, not shown in the figure, that is accessed when SSD 10 and, more specifically, the RAM 6 is powered ON.

The available region information 11 is the information specifying the storage region in the main memory 7 that is available for write and/or read operations. The unavailable region information 12 is the information specifying the storage region in the main memory 7 that is unavailable for write and/or read operations. The availability-pending region information 13 is the information specifying the storage region in main memory 7 that is temporarily unavailable for the write treatment or read treatment. An error count value is included in the availability-pending region information 13 for each storage region referenced in the availability-pending region information 13.

The main memory 7 is a semiconductor memory, for example, a NAND memory. In this embodiment, the configuration described in FIG. 1 has only one main memory 7. However, in some embodiments, there may also be a plurality of main memories 7. The main memory 7 has the data transmitted/received or has the data deleted via memory I/F 4. In this embodiment, the main memory 7 includes the following storage regions: system data region 21, user data region 22, and data holding-state judgment region 23.

The system data region 21 is a storage region for storing the system information needed for the operation of the SSD 10. The user data region 22 is a storage region for storing the data transmitted from the host device 90 (the user data) and the correction code data corresponding to the user data. The data holding-state judgment region 23 is a region for judging (also known as data retention judgment) the data storage holding state. This judgment is carried out by reading, when the power to SSD 10 is turned on, which data are refreshed when the power to SSD 10 is turned off. More specifically, it judges the data storage state, (or holding state) based on the result of the correction process for the data that have been read by SSD 10.

In this configuration, data write operations and/or read operations are executed by the blocks included in the SSD 10 of this embodiment. Also, the blocks included in the SSD 10 manage the information related to the storage regions of the main memory 7 associated with read and write operations. The information related to the storage region is managed, and the data write and/or read operations are executed, to avoid generation of the defective storage region.

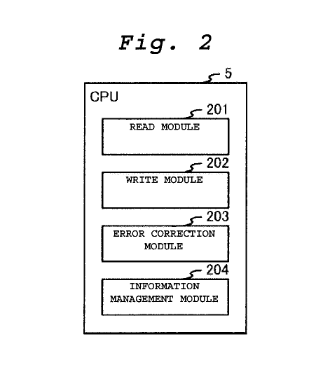

In the following, with reference to FIG. 2, the software module for executing the various operations executed by CPU 5 are explained. FIG. 2 is a block diagram illustrating the configuration of the software module that executes the operations executed with CPU 5 according to an embodiment.

The software module executed with CPU 5 in this embodiment includes a read module 201, a write module 202, an error correction module 203, and an information management module 204. These modules are programs that are stored in a nonvolatile storage region not shown in the figure. These modules are executed by CPU 5 and, as an operation is carried out with the blocks included in the SSD 10, the prescribed operation is executed.

When a read command is requested by host device 90, the read module 201 reads the requested data from the main memory 7 and executes the read operation that transfers the data to the host device 90. The data are obtained after carrying out the prescribed operation on the read data.

The write module 202 executes a write operation in which the data are stored in the main memory 7. The data are obtained by carrying out the prescribed operation on the data transmitted from the host device 90. Also, the write module 202 executes an erasing operation to erase the data recorded in the storage region designated as a recordable region.

The error correction module 203 executes error correction operations to correct data errors based on the data read from the main memory 7 and on the correction code data corresponding to the data. In write operations, the error correction module 203 executes a correction operation that generates the correction code data corresponding to the data associated with the data transmitted from the host device 90. The error correction module 203 judges whether correction can be made on the subject data in data correction operation. When the subject data can be corrected, the number of the correction errors generated with respect to the prescribed unit (such as a data recording unit or read unit associated with the main memory 7) is counted.

The information management module 204 manages the information related to the storage regions of the main memory 7 utilized during write and/or read operations. When write errors and/or read errors occur, the information management module 204 manages the information related to storage regions utilized during the writing or reading operations during which the errors occurred. Specifically, the information managed by information management module 204 related to the storage regions utilized during the write operations and/or the read operations includes whether the region is a defective storage region. Based on the number of correction errors counted by the error correction module 203 and on the determination regarding whether the errors can be carried out, the information management module 204 registers the storage regions utilized during the read and/or write operations as defective storage regions of the main memory 7.

In one embodiment, via the modules executed by the CPU 5, data write and/or read operations are executed. Also, the information related to the storage regions of the main memory 7 utilized during write and/or read operations is managed by these modules. The generation of defective storage regions is discouraged because the information about such storage regions is managed during the execution of data write and/or read operations.

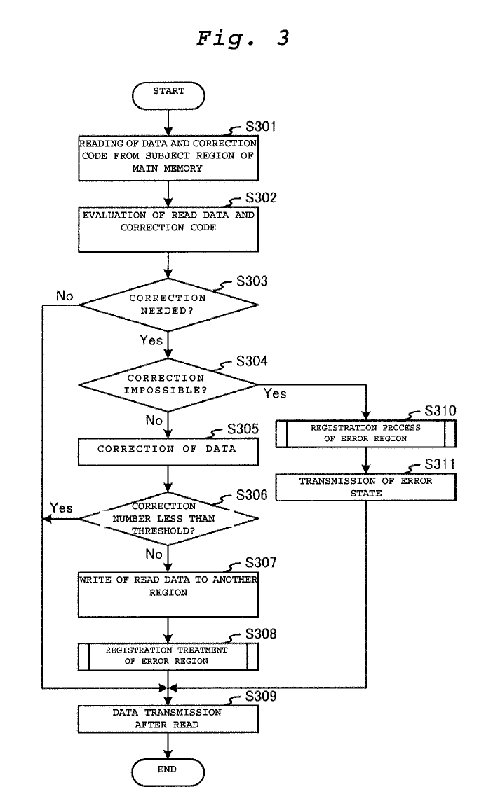

In one embodiment, the execution of a read operation by SSD 10 is explained with reference to FIG. 3.

FIG. 3 is a flow chart illustrating the operation of a read operation executed by SSD 10 according to an embodiment.

The read operation is executed mainly by the read module 201 of CPU 5. In this embodiment, the read operation is executed concurrently with the management of the information related to the storage regions of the main memory 7. Management of the storage-region information occurs while the CPU 5 runs the write module 202.

When a read command is received from the storage region 90, the data corresponding to the read command and the correction code data are read from user data region 22 of the main memory 7 (S301). The read data and the correction code data are evaluated by the ECC control module 3. (S302). Then, a determination is made whether a correction of the read data is needed S303). When correction is needed (YES in S303), the correction is executed and a judgment is made on whether a correction is impossible (S304). When the data can be corrected (NO in S304), the data are corrected by ECC control module 3 (S305).

As a result of the data correction, a judgment is made on whether the error correction number for the prescribed unit is smaller than a predetermined threshold (S306). When the error correction number is not smaller than the threshold (NO in S306), the read data and the correction code data read from the user data region 22 of the main memory 7 are written by the write module 202 in another storage region that is not the read storage region (S307). Then, information management module 204 registers the defective storage region (i.e., the error region) corresponding to the read command (S308). That is, when the error correction number is corrected a large extent from the threshold, and it is possible to become a read error, for the storage region as the subject, the defective storage region (error region) is registered. Also, the data corrected with an error correction number that is not lower than the threshold (i.e., the error correction number is over the threshold) are transferred to the host device 90 corresponding to the data read from the storage region corresponding to the read command (S309), and the read operation comes to an end.

On the other hand, if the determination is made that a correction is not possible (read error) (YES in S304), the information management module 204 registers the storage region corresponding to the read command (S310) That is, in the case of a read error, information management module 204 registers the appropriate storage region as a defective storage region. In addition, the host device 90 is notified of the error state indicating that correction (i.e., read error) is prohibited, and the data that cannot be corrected are transferred to the host device 90 (S309), then the read operation comes to an end.

In addition, when it is not necessary to correct the data as the subject of correction (when the state is normal, so that there is no need to correct the data) (NO in S303), the data are transferred to the host device 90 (S309), then the read operation comes to an end. In addition, when the error correction number is smaller than the threshold (YES in S306) after data correction has taken place, the corrected data with an error correction number that is smaller than the threshold are transferred to the host device 90 (S309), then the read operation comes to an end.

In this way, the modules executed in the CPU 5 are used to execute the read operation according to this embodiment. By means of the read operation according to this embodiment, on the basis of the result of the error correction number and the result about whether a correction can be made with respect to the data read from the storage region as the subject of the read operation, the defective storage region related to the storage region is registered. The registration of the information avoids generating the defective storage.

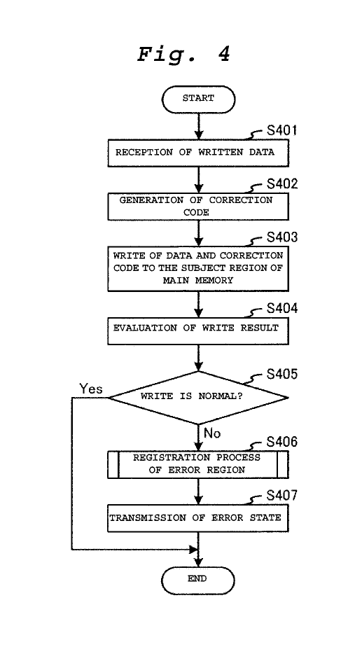

In the following, the operation of the write operation executed by SSD 10 according to an embodiment will be explained with reference to FIG. 4.

FIG. 4 is a flow chart illustrating the operation of the write operation executed by SSD 10 according to an embodiment.

The write operation is controlled as the write module 202 is executed mainly by the CPU 5. In this embodiment, along with the write operation, the storage-region management process is carried out to manage the information related to the storage region of the main memory 7. The storage-region management process is controlled as the CPU 5 runs the information management module 202.

Corresponding to the write command received from storage region 90, the data to be written transmitted from the storage region 90 are received (S401). The error correction module 203 generates the correction code data for correction of the data with respect to the data corresponding to the received data (S402). The data corresponding to the received data and the generated correction code data are written to the user data region 22 of the main memory 7 (S403). The result of this write operation is evaluated (S404). If the result of the write operation is normal (YES in S405), the write operation comes to an end.

On the other hand, the evaluation of the result of the write operation is not normal (i.e., in the case of write error) (NO in S405), by means of the information management module 204, the information registration treatment is executed for the information as the defective storage region (error region) related to the storage region corresponding to the write command (S406). That is, in the case of write error, for the storage region as the subject, the registration process of the information as the defective storage region (error region) is executed. Also, in the state of error corresponding to an abnormal result of the write operation (write error), the host device 90 is notified of the error state (S407), and the write operation comes to an end.

In this way, by means of the plural modules executed by the CPU 5, the write operation of this embodiment is executed. By means of the write operation of this embodiment, on the basis of the result of the write operation to the storage region, the storage region is registered as a defective storage region. The registration process is carried out so that generation of the defective storage region is avoided.

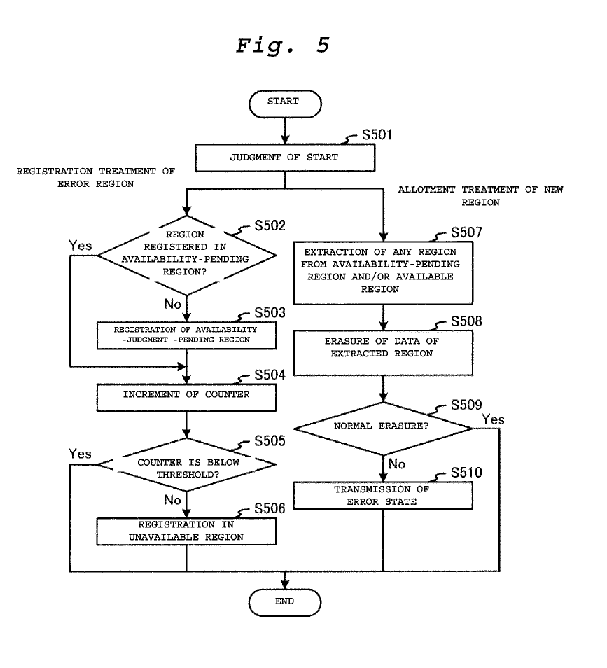

In the following, with reference to FIG. 5, the operation of the storage-region management treatment executed by SSD 10 according to an embodiment will be explained.

FIG. 5 is a flow chart illustrating the operation of the storage-region management process executed by SSD 10 according to an embodiment.

The storage-region management process is controlled as the CPU 5 executes the image management module 202. The storage-region management process is a portion of the read operation or write operation, and it is executed as the registration process of the defective storage region (error region). Also, the storage-region management process is used for newly allotting a portion of the storage region of the main memory 7 so that it can be used in the write operation. That is, in the storage-region management process, at least two processes are executed.

First of all, a judgment is made on the executed treatment (S501). In the case of the registration process of the information as the defective storage region (error region) (registration of the error region), the following operation is executed.

A judgment is made on whether the storage region has been registered in the availability-pending region information 13 in the RAM 6 (S502). When the storage region has not already been registered previously in the availability-pending region information 13 (NO in S502), the information related to the storage region is registered in the availability-judgment-pending region information 13 (S503). When the storage region of interest is already registered in the availability-pending region information 13 (YES in S502), the counter corresponding to the storage region is incremented (S504). Then, whether the incremented counter value is smaller than the threshold is judged (S505). If the counter value is smaller than the threshold (YES in S505), the storage-region management process comes to an end. It is preferred that the threshold be 2 or larger. If the incremented counter value is not smaller than the threshold (NO in S505), the storage region is registered in the unavailable region information 12 (S506), and the storage-region management process comes to an end.

In the storage-region management process of this embodiment, for the storage region of interest, the number of rounds of execution of the registration process is managed corresponding to the counter value. Here, because the counter value is larger than the threshold, the storage region is registered as the unavoidable storage region. In other words, if the counter value is smaller than the threshold, the storage region of interest is managed as the virtual excluding region that is temporarily excluded from those available for storage of information. Because the counter value is larger than the threshold, the storage region of the subject is registered as being a permanently unavailable storage region for storage of information

On the other hand, for the executed treatment, when a portion of the storage region of the main memory 7 is newly allotted to be available for write treatment, the following operation is executed.

A storage region registered as the available region information 11 or the availability-judgment-pending region information 13 is extracted (S507), and the storage region is newly available for a write operation. For extraction of the storage region, priority may be given to any of the following storage regions: the storage region registered in the available region information 11, the storage region registered for either the available region information 11 or the availability-pending region information 13, whichever has the larger quantity (number) of the registered storage regions, and the storage region registered for the availability-pending region information 13. For the data recorded in the extracted storage region, the erasure process is executed by the write module 202 (S508). A judgment is made on whether the result of the erasure process is normal (S509). If the result of the erasure process is normal (YES in S509), the storage-region management process comes to an end. On the other hand, if the result of the erasure process is abnormal (NO in S509), the host device is notified of the error state corresponding to an abnormal result of the erasure operation (erasure error), then the storage-region management process comes to an end.

In the storage-region management process of this embodiment, as a newly allotted storage region is extracted and can be used in the write treatment. The storage region in the available region information 11 or the availability-judgment-pending region information 13 may be extracted. That is, the storage region for which the number of rounds of counting is registered as an error region can be revived as a storage region, and can be used in the write treatment.

In this way, according to this embodiment, for the storage region of the registration subject, when there is a possibility to become a read error or to become a read error or write error, the storage-region management process is executed. Also, even in such case, depending on the counter value corresponding to the information related to the storage region of interest, the defective storage region may not be generated. Consequently, according to the this embodiment, the SSD 10 can suppress generation of the storage regions that are unavailable for storage of information.

According to this embodiment as explained above, when it may become a read error, or when it may become a read error or write error, it is possible to avoid the storage region as the subject from immediately and permanently becoming a defective storage region. Also, the storage region that experiences an error can be revived as a storage region available for a write treatment. Consequently, according to this embodiment, the SSD 10 can be used to suppress generation of storage regions that are unavailable for the storage of information.

The operation can be executed in the read process or write process in normal operation. However, the embodiment is not limited to this state. For example, it may also be executed in the read process or write process in the data retention judgment executed when power is turned on for SSD 10. Also, it may be executed in the read process or write process as associated with self-test using the data holding-state judging region 23 in idle time during conventional operation.

While a certain embodiment has been described, this embodiment has been presented by way of example only, and is not intended to limit the scope of the invention. Indeed, the novel embodiment described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the invention.

What is claimed is:

1. An information storage device comprising:
a semiconductor memory; and
a management unit configured to keep track of a number of errors for each storage region of the semiconductor memory and to make unavailable a storage region having a tracked error number of two or more.

2. The information storage device according to claim 1, wherein the management unit increments a number of errors for a storage region when an error occurs in connection with a read from the storage region.

3. The information storage device according to claim 1, wherein
the management unit manages so that the storage region where the number of rounds when a write error takes place is 2 or more becomes a third prescribed number of rounds among the storage regions of the semiconductor memory and is excluded from use for storing the information.

4. The information storage device according to claim 1, wherein
the management unit manages so that the storage region having a number of rounds of generation of the read error that is smaller than the prescribed number of rounds, the storage region having a number of rounds with the error correction number over a prescribed number smaller than the second prescribed number of rounds, or the storage region having a number of rounds of the write error smaller than the third prescribed number of rounds is managed as the virtual excluding region that is temporarily excluded from use for storing the information; and the storage region having a number of rounds of generation of the read error over the prescribed number of rounds, the storage region having a number of rounds with the error correction number over a prescribed number that is larger than a prescribed number becomes the second prescribed number of rounds, or the storage region having a number of rounds of the write error that become the third prescribed number of rounds is managed as the excluding region permanently excluded from use for storing the information.

5. The information storage device according to claim 1, wherein the management unit increments a number of errors for a storage region when an error correction is performed on data read from the storage region.

6. The information storage device according to claim 1, wherein the management unit is configured to track storage regions as fully available, unavailable, and provisionally available, the provisionally available storage regions having a number of errors that is greater than zero but less than a predetermined threshold value.

7. The information storage device according to claim 6, wherein the predetermined threshold value is two or more.

8. The information storage device according to claim 6, wherein the management unit is further configured to make available for use the storage region that is provisionally unavailable.

9. The information storage device according to claim 8, further comprising:
an erasing unit configured to erase data from the storage region that is provisionally unavailable, the erasing unit erasing data after the management unit makes the provisionally available storage region available for use.

10. A method of reading data from a storage region of a nonvolatile semiconductor memory in an information storage device, the method comprising the step of:
reading data from the storage region; and
when a read error occurs while reading data from the storage region, registering the storage region as a provisionally available storage region,
wherein the provisionally available storage region becomes an unavailable storage region when the number of read or write errors is greater than a predetermined threshold value.

11. The method according to claim 10, further comprising:
during registering the storage region as the provisionally unavailable storage region, incrementing an error number associated with the storage region.

12. The method according to claim 11, further comprising:
determining if the error number is equal to or greater than the predetermined threshold value; and
if the error number is equal to or greater than the predetermined threshold value, registering the storage region as an unavailable storage region.

13. The method according to claim 12, wherein the predetermined threshold value is equal to or greater than two.

14. The method according to claim 11, wherein the error number includes errors resulting from either a read from the storage region or a write to the storage region.

15. The method according to claim 10, wherein a read error occurs when an error correction is not possible for the data read from the storage region.

16. A method of writing data to a storage region of a nonvolatile semiconductor memory in an information storage device, the method comprising the steps of:
writing data to the storage region; and
when a write error occurs while writing data to the storage region, registering the storage region as a provisionally available storage region,
wherein the provisionally available storage region becomes an unavailable storage region when the number of read or write errors is greater than a predetermined threshold value.

17. The method according to claim 16, further comprising:
during registering the storage region as the provisionally unavailable storage region, incrementing an error number associated with the storage region.

18. The method according to claim 17, further comprising:
determining if the error number is equal to or greater than the predetermined threshold value; and
if the error number is equal to or greater than the predetermined threshold value, registering the storage region as an unavailable storage region.

19. The method according to claim 18, wherein the predetermined threshold value is equal to or greater than two.

20. The method according to claim 17, wherein the error number includes errors resulting from either a read from the storage region or a write to the storage region.
